(19) United States
(12) Patent Application Publication
(10) Pub. No.: US 2011/0010548 A1
(43) Pub. Date: Jan. 13, 2011

(54) SECURE E-MAIL SYSTEM

(76) Inventors: Angus Stewart, Staffs (GB); Jonathon Barton, Derby (GB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/669,380

(22) PCT Filed: Jul. 18, 2008
(86) PCT No.: PCT/GB08/02467

§ 371 Date: Sep. 24, 2010

(30) Foreign Application Priority Data
Jul. 18, 2007 (GB) 0713915.7

(51) Int. Cl. H04L 9/00; H04L 9/08; H04L 9/32

(52) U.S. Cl. 713/170; 380/277

(57) ABSTRACT

An email system for securely sending an email message to a recipient comprising: one or more computers connected to the internet at least one of computer being suitable for receiving data identifying a recipient; a communicator for sending messages; an encryption engine configured to encrypt the email message using the encryption key to produce an encrypted email message; a computer of the one or more computers programmed to identifying an encryption key; a computer of the one or more computers programmed to identify a first contact identifier of the recipient based on data received by a computer of the one or more computers, and to determine a first address of the recipient from the first contact identifier; a computer of the one or more computers programmed to determine a second address of the recipient from data received by the input means or from the first contact identifier using a lookup table or database; wherein at least the first address is an email address and the email system is configured to send the encrypted email message to the email address of the recipient and create an encryption key message, containing the encryption key, and send to the second address of the recipient.

The present invention is concerned with the sending of secure messages by email.

Known email systems operate by a sender composing an email message using a mail client. Mail clients take many forms and may be, for example, specific software installed on the user's computer or alternatively remote software operated over the interne via a browser.

The user, alone or in conjunction with the client (using, for example an address book) then provides a recipient email address. Upon instructing the client to send the email message, the client formats the message for sending and uses an appropriate protocol (for example the simple mail transfer protocol, SMTP) to a mail transfer agent (MTA).

The MTA may be in a variety of locations, for example on the sender's computer, or hosted by the user's internet service provider (ISP). The MTA extracts the recipient email address provided by the mail client, and subsequently extracts the domain name from the recipient address (the portion of the email address following the @ character).

The MTA then looks up the domain name in the domain name system (DNS) for appropriate mail exchange (MX) servers for that domain. The DNS server for the recipient's domain then reports back to the MTA with a list of MX servers. The MTA then sends the message to the MX using an appropriate protocol (e.g. SMTP). The MX then delivers the email message to the recipient's mailbox (and subsequently his email client).

The number of stages involved in transferring the email message from sender to recipient means that email messages are commonly stored in a number of computer systems. Furthermore, as these systems are regularly backed up in case of failure, a “virtual paper trail” develops in which a number of copies of the email message are stored in various locations even after the message has been delivered.

As the user has little control over where and how the transient email message is stored, he has little control over who can access the email message. As such, email is an inherently insecure method of communication.

A known solution to this problem is to utilise encryption, in which the email message is encrypted such that only the recipient's mail client may open it. This means that the transient message is unreadable by third parties.

However, known encryption methods are not without their disadvantages. The communication of a key between sender and recipient is essential in private (symmetric) key encryption methods which is conventionally time consuming and not necessarily secure. Although public (asymmetric) key encryption (e.g. PGP, PKI systems) partly alleviates this problem the decryption step is often many times longer than with private key encryption.

Additionally, known systems require some input by the recipient; e.g. they must provide a public key to the sender for encryption.

The clients used by the sender and recipient can also exhibit privacy flaws. Commonly, a password is required to access the user's mailbox. In order to save time the password is often stored by the user's computer such that they have “instant” access to their mailbox. As such, it is relatively easy for a third party to gain access to the mailbox. Similarly, the user may log in on a shared computer, neglect to log out and as such leave their mailbox vulnerable to access by third parties, even if the email was encrypted.

It is an object of the present invention to overcome one or more of the above security problems.

According to a first aspect of the invention there is provided an email system for securely sending an email message to a recipient comprising:
a computer connected to the internet comprising input means suitable for receiving data identifying a recipient;
message sending means;
means for identifying an encryption key;
an encryption engine configured to encrypt the email message using the encryption key to produce an encrypted email message;
means for identifying a first contact identifier of the recipient based on data received by the input means wherein the first contact identifier corresponds to, and preferably comprises, an email address of the recipient;
means for identifying a second contact identifier of the recipient based on data received by the input means;
wherein the email system is configured to send the encrypted email message to the email address of the recipient and create an encryption key message, containing the encryption key, and send to a second address corresponding to the second contact identifier of the recipient, and preferably the second contact identifier comprises the second address.

According to a second aspect of the invention there is provided an email system for securely sending an email message to a recipient comprising:
a computer connected to the internet comprising input means suitable for receiving data identifying a recipient;
message sending means;
means for identifying an encryption key;
an encryption engine configured to encrypt the email message using the encryption key to produce an encrypted email message;
means for identifying a first contact identifier of the recipient in based on data received by the input means, and determining a first address of the recipient from the first contact identifier;
means for determining a second address of the recipient from data received by the input means or from the first contact identifier using a lookup table or database;
wherein at least the first address is an email address and the email system is configured to send the encrypted email message to the email address of the recipient and create an encryption key message, containing the encryption key, and send to the second address of the recipient.

Further aspects and features are set out in the claims.

An email system in accordance with the present invention will now be described in detail and with reference to the accompanying figures in which:

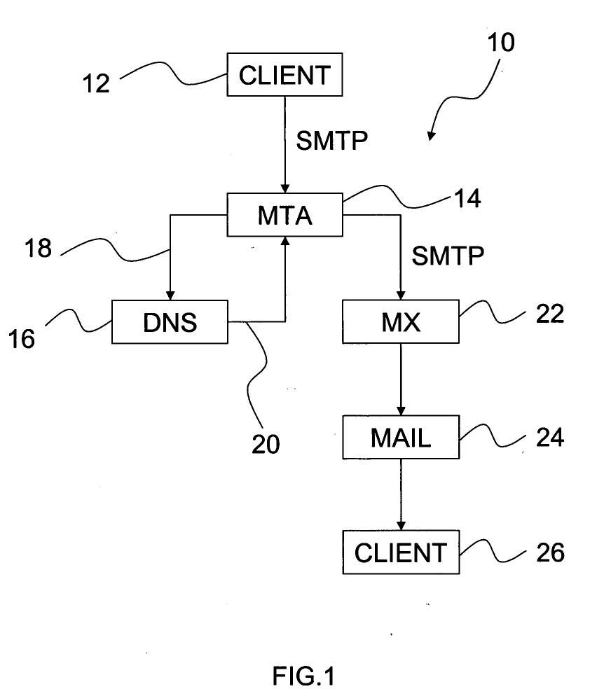

FIG. 1 is a schematic representation of a known email system;

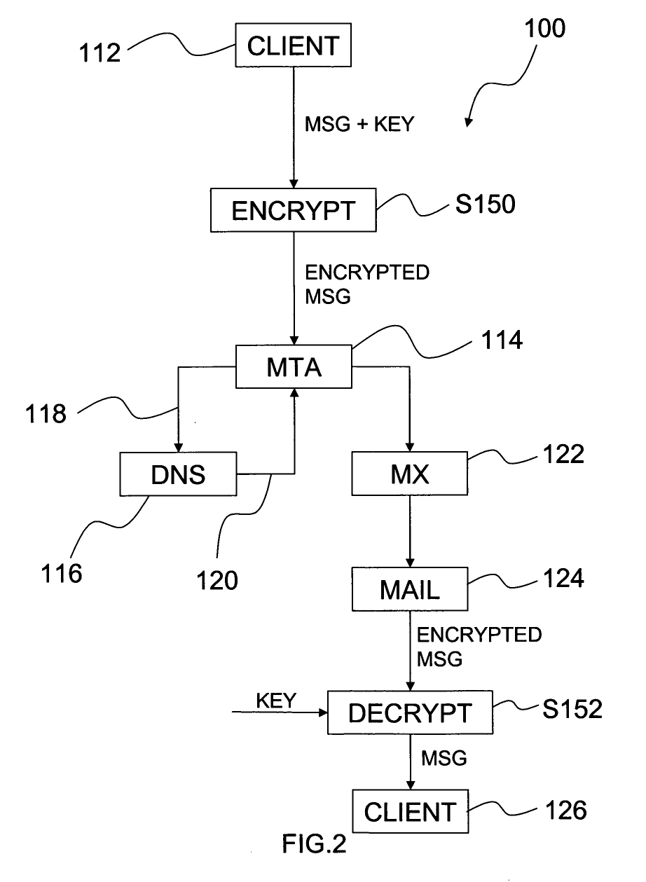

FIG. 2 is a schematic representation of an email system employing a private key encryption method;

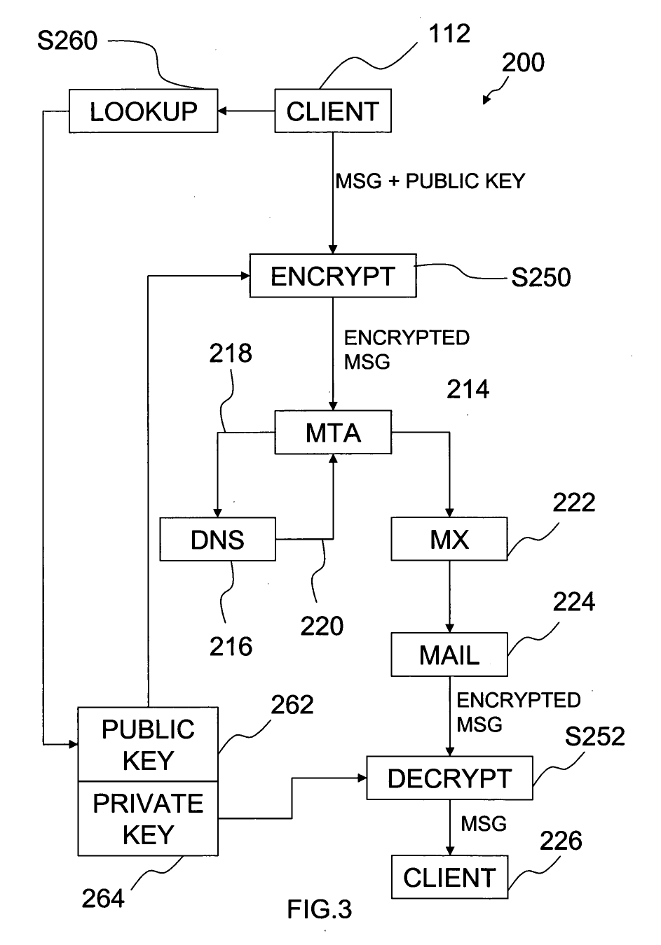

FIG. 3 is a schematic representation of an email system employing a public key encryption method;

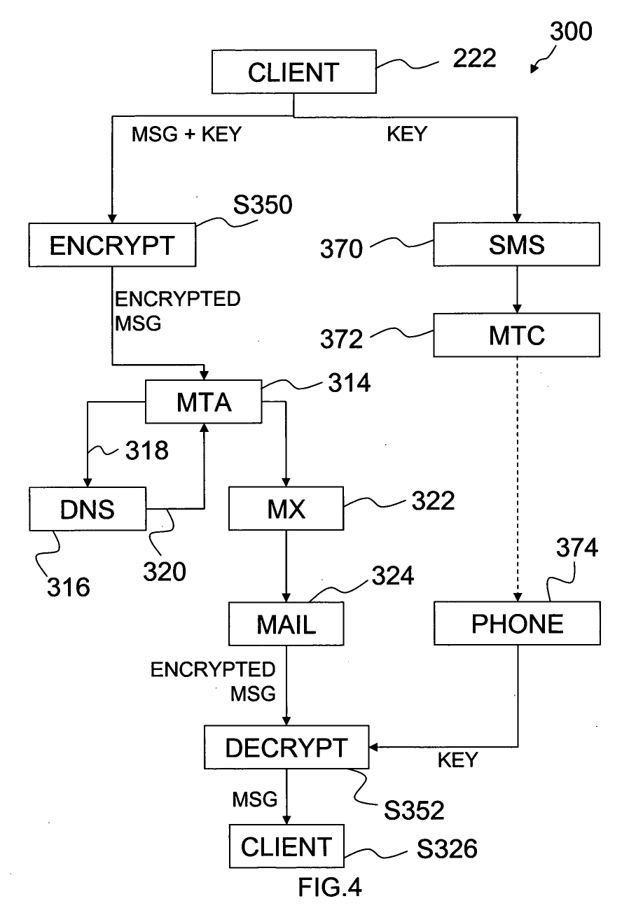

FIG. 4 is a schematic representation of a first embodiment of an email system in accordance with the present invention;

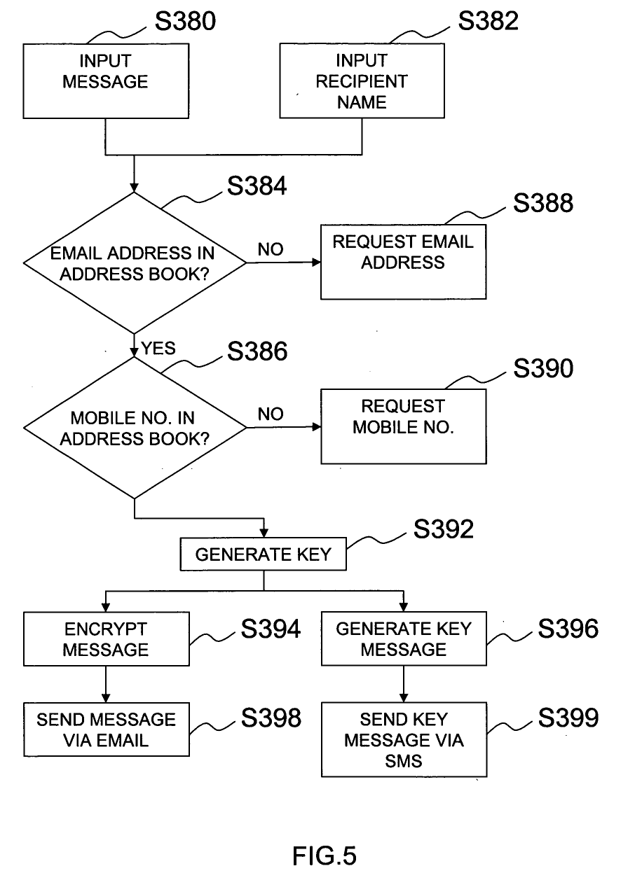

FIG. 5 is a schematic representation of a second embodiment of an email system in accordance with the present invention;

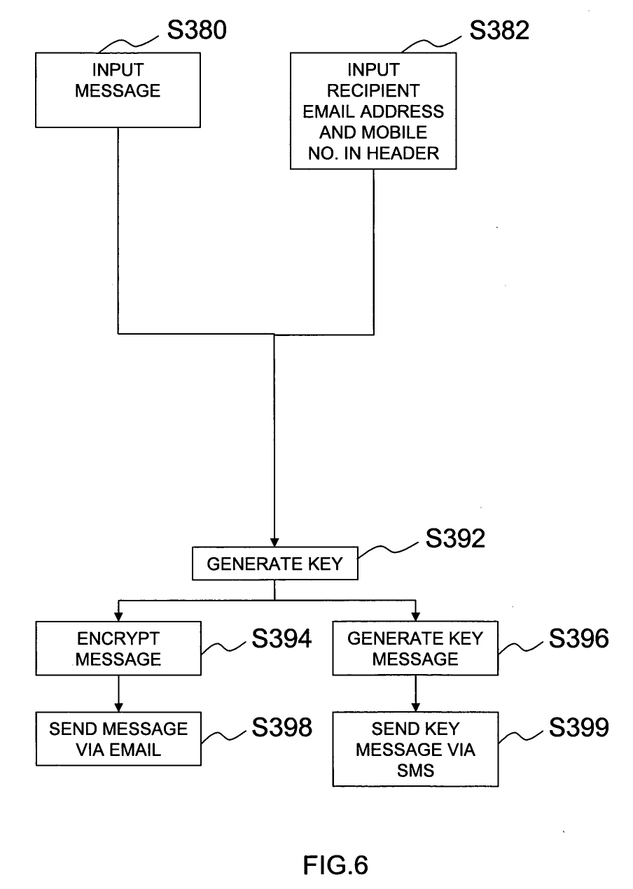

FIG. 6 is a schematic representation of a third embodiment of an email system in accordance with the present invention;

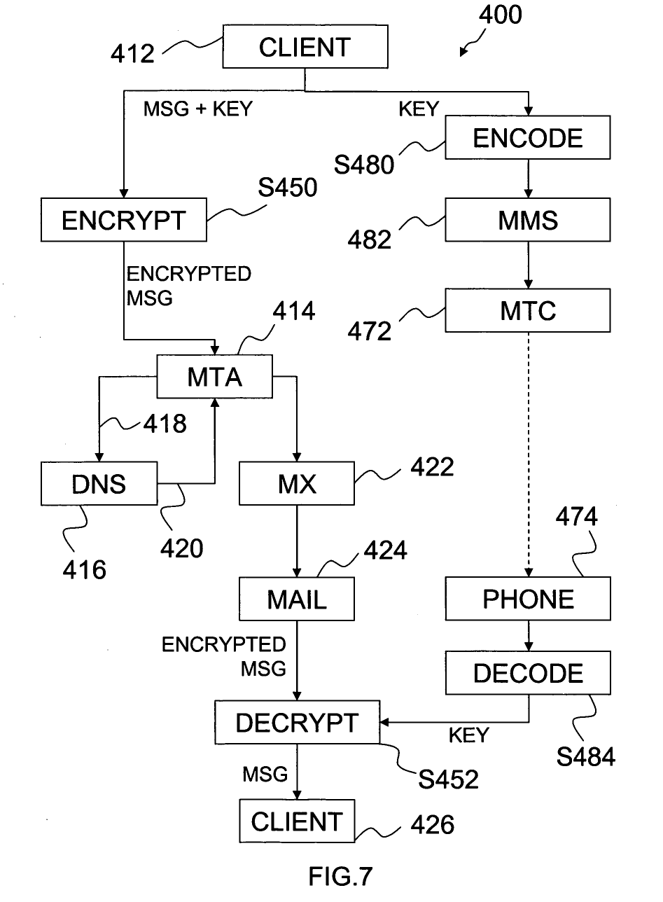

FIG. 7 is a schematic representation of a fourth embodiment of an email system in accordance with the present invention;

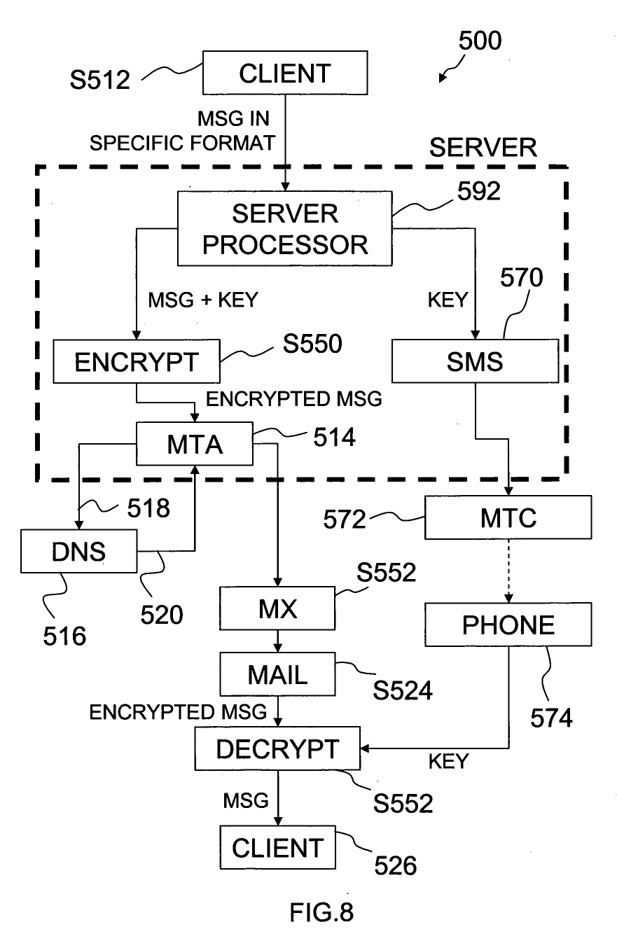

FIG. 8 is a schematic representation of a fifth embodiment of an email system in accordance with the present invention;

Referring to FIG. 1, a known email system 10 is shown schematically in which an email client 12, operated by a user is used to compose an email message. As described above, the client 12 formats the message for sending and uses an appropriate protocol (for example the simple mail transfer protocol, SMTP) to a mail transfer agent (MTA) 14 using a communicator such as a modem (which may also be used for sending the messages in the embodiments described below.)

The MTA 14 may be in a variety of locations, for example on the sender's computer, or hosted by the user's internet service provider (ISP). The MTA 14 extracts the recipient email address provided by the mail client, and subsequently extracts the domain name from the recipient address (the portion of the email address following the @ character).

The MTA then looks up the domain name in the domain name system (DNS) 16 for appropriate mail exchange (MX) servers for that domain via a DNS request 18. The DNS server for the recipient's domain then reports back to the MTA with a list of MX servers 20. The MTA then sends the message to the appropriate MX 22 using an appropriate protocol (e.g. SMTP). The MX then delivers the email message to the recipient's mailbox 24 (and subsequently his email client 26).

FIG. 2 shows an email system 100 employing private (symmetric) key encryption. Common features of the system 100 to the system 10 are numbered 100 greater. An additional encryption step S150 is employed by the email client 112 in which the message is encrypted in a known manner using a private key known to the sender and inputted into the client. The encrypted message is then treated as the message in system 10 with the exception that a decryption step S152 is performed at the recipient's client 126.

In order to perform the decryption step 152 the recipient needs to know the private key. As such the sender needs to manually communicate this to the recipient verbally, or by email, which will arrive at the sender's mailbox and hence be accessible to any third parties who have access to his mail.

An alternative method to system 100 is shown in FIG. 3, where an email system 200 (common features with system 10 numbered 200 greater) is shown. Email system 200 employs public (asymmetric) key encryption. Rather than the sender generating the encryption key, the client 212 performs a lookup operation S260 against the recipient's identity to retrieve his public encryption key 262. The public key 262 is then returned to the client to perform an encryption step S250.

Upon delivery to the recipient, the recipient's client can perform a decryption step S252 using the private (decryption) key 264 known only to the recipient.

An email system 300 according to the present invention is shown in FIG. 4 (common features with system 10 numbered 300 greater). The email system 300 is similar to email system 100 in that it utilises private key encryption. However, system 300, instead of comprising means for looking up the public key of the recipient at step 260, comprises means for sending an SMS message 370 via a mobile telephone company 372. In system 300, the recipient also has a mobile telephone 374.

In use, as shown in FIG. 5, the email client (although the step may be performed by the MTA if appropriate), as well as encrypting the message at step 350 also prepares the SMS (short message service) message 370 containing the private key. The SMS message is then communicated to the mobile telephony company 372 at which point it is send via text message to the recipient's mobile telephone 374. The recipient can then enter the private key into his client to decrypt at step S352 to retrieve the message.

The method is shown in FIG. 5 in which the user inputs the message for encryption at step S380 and also the name of the recipient at step S382. The system then checks an address book for the presence of both an email address and a mobile telephone number for the recipient at steps S384, S386 and requests them at steps S388, S390 if none are found.

When the email address and mobile number is determined, the system then generates a key at step S392, either randomly or via user input and encrypts the message at step S394. Simultaneously, the key message is generated at step S396 and both the encrypted message and key message are sent at steps S398 and S399 respectively.

An alternative method is shown in FIG. 6 in which the recipient email address and mobile telephone number is directly input in, for example, the message's header.

A similar arrangement to system 300 is shown in FIG. 7 in which an email system 400 (common features with system 10 numbered 400 greater) is substantially similar to system 300. System 400 incorporates an additional level of security by encoding the private key at step S480. The key is encoded by transforming it into a bitmap and sending as an MMS (multimedia message service) message 482 to the recipient's mobile telephone 474. The recipient can then decode the key at step 484 by reading the key from the bitmap and using it to decrypt the email message at step S452.

This method provides an extra level of security as a bitmap is more difficult to intercept and decode than a simple text string SMS message. Furthermore, human intervention is required to read the bitmap and convert it back to a text string.

A similar arrangement to system 300 is shown in FIG. 8 in which an email system 500 (common features with system 10 numbered 500 greater) is substantially similar to system 300.

In system 500, instead of the sender using a specialised email client, client S512 is simply a standard client capable of preparing email messages. In system 500, there is a server 590 which upon receipt of the email is configured to determine whether the sender requires encryption to be used. This may be indicated, for example by a keyword in the subject line or header of the email message, or simply the recipient's mobile telephone number in the header of the email message.

The server processor 592 upon receipt of the email determined that encryption is required and consequently prepares and sends the encrypted email and SMS as per system 300. Advantageously, the user requires no special software to use this system, only knowledge of the format which the email message for encryption needs to be in (e.g. with the mobile number in the subject line).

The private key for systems 300, 400 may be generated by the recipient, or preferably randomly generated by the client. As such, a new key is generated every time and the chance of discovery by third parties is less. Additionally, computer generated keys are more likely to consist of a random sequence of characters and as such are inherently more secure against dictionary related brute force searches than human generated keys.

In the above examples, the recipient's mobile telephone number is stored in the sender's address book, within his client. Therefore when a secure email needs to be sent, the client can look up the recipient's number against his email address.

Alternatively, the sender may manually enter the recipient's number. Alternatively, if the client does not have the recipient's number stored, the client may automatically request it via email. As such the recipient will be unable to read the encrypted email until he has responded.

Numerous changes may be made to the above embodiments. For example, the method by which the private key is communicated need not be SMS or MMS, but could be an instant messaging service, fax or post (the client preparing the letter for printing and sending).

Alternatively, a number of methods could be employed. For example the client could check to see if the recipient is logged onto an instant messaging service. If so, then an instant message would be sent. If not, then the client would check for a mobile telephone number. If one was present then an SMS would be sent, if not then an email request could be sent for such a number.

The various steps may occur at different locations within the chain of communication. In fact a third party may carry out steps S394, S396, S398, S399 and send the encrypted message and key message onto the recipient. This would eliminate the need for the sender to possess any special encryption software, rather they send the unencrypted email to the third party with the relevant information in the header, where it is used by the third party to complete the above steps.

Alternatively, the recipient may decide they require email from certain addresses to be encrypted, in which case they provide their ISP with their mobile telephone number. Incoming mail can then be encrypted at the MX using a lookup table or database such that if the recipient uses a shared computer, for example, other users cannot access the encrypted emails. In this embodiment, the sender has no knowledge of the encryption process.

It may not be necessary for a new key to be generated every time and email is sent. The system may allocate the recipient a key the first time they are sent an encrypted email in accordance with the present invention, which they then use to decrypt subsequent emails. The system may store the recipient's key and use it to encrypt any subsequent emails without the need to send an SMS message or equivalent. Similarly, the system may send the recipient a single private key, and generate a public key for use with subsequent email message encryption.

In alternative embodiment a publics key encryption can be used. similar to that shown in FIG. 3 but using a PKI to authenticate that the public key corresponds to the correct recipient using certificates so that at step S260 a PKU certificate is obtained. In order to avoid a malicious third party interfering with the lookup/certificate process S260 and sending a false public key so that they instead of the intended client 226 have the private key which will decrypt the message, the newly issued PKI certificate is password protected.

The password for the newly issued PKI certificate is sent by text message by the client 226 to a mobile phone owned by client 212. Again in preferred embodiments for extra security the password may be sent as a bitmap in an MMS. The client 212 can then use this password to access the certificate and the public key and can check that the password was valid and that it was received from the telephone number of the client 226 using conventional methods such CLI (caller line identification)/ANI (automatic number identification). The password is preferably a one time only password.

1-18. (canceled)

19. A method for securely sending an email message to a recipient comprising the steps of:
identifying an encryption key;
encrypting the email message using the encryption key to produce an encrypted email message;
identifying a first contact identifier of the recipient wherein the first contact identifier is an email address of the recipient;
identifying a further contact identifier of the recipient;
sending the encrypted email message and preparing an encryption key message, containing the encryption key, for sending to the alternative contact identifier of the recipient.

20. An email system for securely sending an email message to a recipient comprising:
one or more computers connected to the internet at least one of the computers being suitable for receiving data identifying a recipient;
a communicator for sending messages;
an encryption engine configured to encrypt the email message using the encryption key to produce an encrypted email message;
a computer of the one or more computers programmed to identify an encryption key;
a computer of the one or more computers programmed to identify a first contact identifier of the recipient in based on data received by a computer of the one or more computers, and to determine a first address of the recipient from the first contact identifier; and
a computer of the one or more computers programmed to determine a second address of the recipient from data received by the input means or from the first contact identifier using a lookup table or database;
wherein at least the first address is an email address and the email system is configured to send the encrypted email message to the email address of the recipient and create an encryption key message, containing the encryption key, and send to the second address of the recipient.

21. An email system according to claim 20, wherein a computer of the one or more computers programmed to identify a second contact identifier of the recipient based on data received,
and a computer of the one or more computers is programmed to determine the second address from the identified second contact identifier.

22. An email system according to claim 27, wherein the means for determining the second address is configured to determine the second address by referring the first contact identifier against a database or lookup table containing one or more addresses.

23. An email system for securely sending an email message to a recipient comprising:
a computer connected to the internet comprising an input for receiving data identifying a recipient;
a message sending communicator;
the computer programmed to identify an encryption key;
an encryption engine configured to encrypt the email message using an encryption key to produce an encrypted email message;
the computer programmed to identify a first contact identifier of the recipient based on data received by the input wherein the first contact identifier corresponds to, and preferably comprises, an email address of the recipient;
and programmed to identify a second contact identifier of the recipient based on data received by the input;
wherein the email system is configured to send the encrypted email message to the email address of the recipient and create an encryption key message, containing the encryption key, and send the encryption key message to a second address corresponding to the second contact identifier of the recipient, and preferably the second contact identifier comprises the second address.

24. An email system for securely sending an email message to a recipient comprising:
one or more computers connected to the internet at least one of which is suitable for receiving data identifying a recipient;
a communicator for sending messages;
an encryption engine configured to encrypt the email message using the encryption key to produce an encrypted email message;
a computer of the one or more computer is programmed to identifying an encryption key;
a computer of the one or more computers is programmed to identify a first contact identifier of the recipient based on data received wherein the first contact identifier corresponds to, and preferably comprises, an email address of the recipient;
a computer of the one or more computers is programmed to identify a second contact identifier of the recipient based on data received by the input means; and
a computer of the one or more computers is programmed to identify a password in a message containing the second contact identifier of the recipient;
wherein the email system is configured to send the encrypted email message to the email address of the recipient using an encryption key corresponding to the recipient identified using the password.

25. An email system according to claim 20, in which the second contact identifier is a mobile telephone number and the encryption key message or password message is sent as a readable mobile telephone message, such as, SMS or MMS, to the mobile telephone number.

26. An email system according to claim 20, in which the second contact identifier is an instant messaging ID and the encryption key message or password message is an instant message.

27. An email system according to claim 20, in which the computer identifies the second contact identifier of the recipient using an address book, and the email system is configured to extract the further contact identifier from the address book upon identification of the first contact identifier.

28. An email system according to claim 20, wherein a computer of the one or more computers is programmed to encoding the encryption key or password message.

29. An email system according to claim 28, in which the computer encodes the message by generating a bitmap from the encryption key or password.
